(19) United States
(12) Patent Application Publication
(10) Pub. No.: US 2014/0275398 A1
(43) Pub. Date: Sep. 18, 2014

(54) POLYMER COMPOSITION HAVING GLASS FLAKE REINFORCEMENT

(71) Applicant: TP Composites, Inc., Aston, PA (US)

(72) Inventors: Johnson C. Watkins, Newark, DE (US); David Berry, Austin, TX (US)

(73) Assignee: TP Composites, Inc., Aston, PA (US)

(21) Appl. No.: 13/832,560

(22) Filed: Mar. 15, 2013

(51) Int. Cl. C08L 61/02; B29C 43/00

(52) U.S. Cl. CPC C08L 61/02; B29C 43/003
USPC 524/542; 264/319

(57) ABSTRACT

A PEEK resin compound used to injection mold tubes which are machined into backup rings for high temperature seal assemblies which provides high dimensional stability during assembly and improved extrusion resistance in use which is comprised of glass flake and/or glass fiber. Various embodiments are disclosed wherein the glass flake is combined with glass fiber and wherein the resin ratio is varied.

### FIELD OF THE INVENTION

The present invention relates generally to seal rings made of reinforced composite materials, and in particular to those made from glass reinforced polymers.

### BACKGROUND OF THE INVENTION

It is known in the art to make precision geometry back up rings from a glass fiber reinforced Polyaryletherketone, such as PEEK resin. Back up rings are anti-extrusion devices to hold an elastomer seal in place under temperature and pressure. For example, seals used in pressurized hoses or piping connections found in down hole oil and gas operations. Reinforcing glass fiber for use in engineering thermoplastics (ETP), such as PEEK, Polyamide and polypropylene is supplied in two common diameters, 10 micron (10 u) and 13 micron (13 u). It is also known in the art that an inverse relationship exists between fiber diameter and mechanical strength obtained in glass fiber reinforced semi-crystalline ETP's such as those mentioned.

Reinforcing glass fibers are generally supplied from a glass composition known as ‘E’ or ‘ECR’ glass. These are borosilicate glasses known for their superior dielectric insulating properties and strength & modulus versus weight properties. Fibers made from other glass compositions, such a ‘C’ glass are also suitable. These reinforcing fibers are supplied with surface treatments or sizings designed to enhance compatibility, wetting, and stress transfer from the matrix resin to the reinforcing fiber. Typically, a specific fiber diameter and fiber sizing are selected for the intended resin to be reinforced. The reinforcing fibers are extrusion compounded into a thermoplastic resin, such as PEEK, to produce a granular molding compound.

In the manufacture of precision backup rings, the fiber reinforced thermoplastic molding compound is injection molded into the shape of a tube. In typical applications, the tube is between 1 and 24 inches in outer diameter, will have a wall width thickness between ¼ inch and 2 inches and be 3-20 inches tall. These dimensions are illustrative only and other sizes are certainly possible. The molded tube is oven annealed to fully crystallize the PEEK resin and to reduce molded-in stresses. The tube is used as a substrate from which precise geometry rings are machined. A finished ring is then scarf-cut (cut on an angle) and annealed again. The current state of the art is that at this point in the manufacturing process, approximately 20-30 percent of the split rings deform, either with the cut ends pulling in past one another or pulling apart. These are both defects which are cause for rejection. Some styles of back-up rings are not scarf-cut and these too, can deform out of plane, as a result of the annealing process. Distortion out of plane or no longer being flat, can render uncut rings to be un-usable.

The molded tubes tend to be more than ¼″ thick because thicker tubes are easier to mold. For example, a ¼″ ring is machined from the OD of the tube and also from the ID. The OD ring, when scarf-cut tends to spring in one direction. The ID ring tends to spring in the opposite direction when scarf-cut. It is not uncommon for the amount of spring to vary only in the axial direction of the tube. The spring is probably greater than 20-30% out of roundness.

Semi-crystalline resins, when they crystallize, either in the solid state via annealing or from a molten state during injection molding, shrink 3-4 time more, compared to amorphous resins. Amorphous resins are defined as polymers which do not crystallize. Semi-crystalline resins exhibit far superior thermal and chemical resistance than amorphous polymers, and thus ideally suited for use in harsh environments, such as found in oil and gas processes and chemical process industries. During melt processing of fiber reinforced resins, such as injection molding or extrusion, reinforcing fibers become disproportionately oriented parallel to the direction of flow of the molten polymer in either semi-crystalline or amorphous resins. The fibers then prevent the crystallizing polymer from shrinking as much in the aligned direction. The polymer shrinks a great deal more in the perpendicular direction of flow because of the uneven or anisotropic orientation of the fiber. This non-uniform 3D shrinkage causes distortion in the final shape of the mold plastic component and is referred to as warpage. Warpage is much more of a problem with semi-crystalline resins, as compared to amorphous resins because of the shrinkage effect created by crystallization. Deformation of machined split rings for seals is thus directly caused by non-uniform shrinkage of the plastic.

Thus, a need exists for an improved glass reinforced polymer seal ring that does not have the warping propensity of known glass fiber reinforced rings.

### SUMMARY OF THE INVENTION

In accordance with one aspect of the invention there is provided a compound for use in injection molded parts. The compound includes either PEEK resin, PEK resin or PEKK resin; and glass flake. In a further embodiment, the compound has a resin ratio of less than 100%. In a further embodiment, the compound has a resin ratio is between 60% and 80%.

In a further embodiment of any of the foregoing embodiments the compound contains glass fiber. In a further embodiment of any of the foregoing embodiments the compound has a glass flake to glass fiber ratio of 2 to 1.

In a further embodiment of any of the foregoing embodiments the resin is a combination of high and low viscosity resins.

In a further embodiment there is disclosed a method of fabricating a reinforced item. The method includes the steps of providing a compound having either PEEK, PEK or PEKK resin; and glass flake and extruding the compound by rod or sheet extrusion.

In a further embodiment, there is disclosed a method of fabricating a reinforced item. The method consists of the steps of providing a compound having either PEEK, PEK or PEKK resin; and glass flake and molding the compound to form the item. In a further embodiment, the item is formed by compression molding.

### DETAILED DESCRIPTION OF THE PREFERRED EMBODIMENT

Without further elaboration the foregoing will so fully illustrate our invention that others may, by applying current or future knowledge, adopt the same for use under various conditions of service.

It is known in the art that blends of reinforcing fibers and mineral fillers can reduce anisotropic shrinkage (flow versus transverse flow) which yields flatter, less warped parts. Minerals like kaolin clay, talc and calcium carbonate are spherical in shape and have an aspect ratio of 1. Aspect ratio is particle length/diameter. Above a certain aspect ratio (>1), translation of stress from the polymer to the filler occurs which causes an increase in strength (i.e. reinforcement). Milled fiber is fiber that has been subjected to various mechanical treatments to reduce the fiber length. Milled fiber does not generally impart significant reinforcing effect, due to the aspect ratio being low. Mica, which has a platelet structure is known to work efficiently at inducing flatness/reduced warpage-in-plane and does have an “aspect ratio” but the ratio is usually below that necessary to impart reinforcement.

Contrary to expectations based on the aspect ratio property discussed above, the inventor has found that the introduction of glass flake into the fiber reinforced compound improves the performance of an anti-extrusion back up ring and reduces the extent of deformation in the cutting process. The formulation provides low spring back performance while delivering surprisingly exceptional strength and stiffness. Adding mineral powders, hollow glass bubbles or solid glass beads as in the prior art formulation provides no reinforcement benefit and unacceptable mechanical strength but low spring back. A mixed fiber length prior art formulation of glass fiber and milled glass fiber provides moderate strength and stiffness and limited spring back. The inventor believes that reduced deformation in the ring is the result of the glass flakes providing more isotropic (random) orientation with reinforcing properties in the part in contrast to glass fibers which are known to highly orient with the flow direction of the polymer as it fills the cavity during molding.

Tests were made of blends of milled glass fiber and reinforcing glass fibers ‘A’ and compared to blends of glass flake and reinforcing glass fibers ‘E.’ Higher mechanical properties were observed with the flake blend. The mixture of flake and glass fiber appears to act synergistically to impart higher strength and stiffness as compared to blends of glass fiber and milled glass fiber. The resin used was VESTAKEEP® 4000G

| | A | B | C | D | E |
|---|---|---|---|---|---|
| Filler, 30% | GF/Milled | 10 u GF | Milled | Flake | Flake/GF |
| Tensile @ yield (PSI) | 15,025 | 20,602 | 10,744 | 11,354 | 16,250 |
| Tensile @ break (PSI) | 16,202 | 21,988 | 11,480 | 12,212 | 17,100 |
| elong @ break % | 5.2 | 5.2 | 4.6 | 4.5 | 4.2 |
| Notched Izod | 1.47 | 2.00 | 1.09 | 0.86 | 1.35 |
| % ash | 29.9 | 29.7 | 29.4 | 30.1 | 30.3 |
| Specific Gravity | 1.5236 | 1.5218 | 1.5151 | 1.5127 | 1.515 |
| Shrinkage (in.) | 0.005 | 0.0026 | 0.0084 | 0.0066 | 0.005 |
| Flex modulus (PSI) | 955,478 | 1,232,244 | 742,560 | 862,201 | 935,471 |

Further tests were made comparing larger diameter (13 u) glass fiber, mica sized reduced so that 100% of the particle passed thru a 325 mesh screen and surface treated wollastonite (calcium silicate), a naturally occurring fiberous mineral. VESTAKEEP® 4000G was used in these tests and as the reference sample I. The results obtained demonstrate that a platelet particle, such as mica, (sample G) is far inferior for reinforcing PEEK, as compared to glass flake, sample E, above. Likewise sample H, is inferior in reinforcing performance to milled glass fiber sample C.

| | F | G | H | I |
|---|---|---|---|---|
| Resin | 4000 | 4000 | 4000 | 4000 |
| Filler, 30% | 13 u GF | Mica | Wollastonite | control |
| Tensile @ yield (PSI) | 20,487 | 9,300 | 8,800 | 14,000 |
| Tensile @ break (PSI) | 21,408 | 9,100 | 8,900 | 13,500 |
| elong @ break % | 4.7 | 2 | 2 | 50 |
| Notched Izod | 1.63 | 0.9 | 0.88 | 1.6 |
| % ash | 28.9 | 30 | 31.1 | 0 |
| Specific Gravity | 1.5134 | 1.523 | 1.512 | 1.3 |
| Shrinkage (in.) | 0.003 | 0.008 | 0.009 | 0.016 |
| Flex modulus (PSI) | 1,211,138 | 725,000 | 755,000 | 595,000 |

Since reinforcing fibers align with the direction of flow, additional test compositions were made with blends of high viscosity (VESTAKEEP® 4000G) and low viscosity (VESTAKEEP® 2000G) polymer to assess if linear mold shrinkage changes. By adding more low viscosity as a percentage of the total polymer, the melt viscosity is reduced. As the viscosity decreases, mechanical properties increase, especially with semi-crystalline resins. Blending resins of different molecular weights or melt viscosities to affect an increase or decrease in orientation of reinforcing fibers is used for illustrative purposes only. Those skilled in the art may utilize other methods of adjusting the melt viscosity of the resultant compound, and those techniques are incorporated by reference.

| | E | J | K |
|---|---|---|---|
| Resin | 4000 | 4000/2000 | 4000/2000 |
| Resin Ratio | 100 | 80/20 | 60/40 |
| Filler, 30% | Flake/GF | Flake/GF | Flake/GF |
| Tensile @ yield (PSI) | 16,250 | 17,350 | 17,750 |
| Tensile @ break (PSI) | 17,100 | 18,300 | 18,800 |
| elong @ break % | 4.2 | 4.2 | 4.2 |
| Notched Izod | 1.35 | 1.40 | 1.45 |
| % ash | 30.3 | 29.2 | 31.0 |
| Specific Gravity | 1.515 | 1.510 | 1.521 |
| Shrinkage (in.) | 0.005 | 0.006 | 0.007 |
| Flex modulus (PSI) | 935,471 | 931,210 | 934,111 |

*fiber/flake ratio 33/66

In further embodiments, glass flakes can be selected on the basis of glass composition, surface sizing treatment and particle size distribution. Likewise, those skilled in the art would also know to vary the weight or volume fraction ratio of flakes and reinforcing fibers. In addition, other polyarylketones, such as, but not limited to, PEK, PEKK, PAEK etc. are suitable base resins for low spring back compositions.

The foregoing embodiments are illustrative and in no way meant to limit the scope of the invention.

We claim:

1. A compound for use in injection molded parts comprising:
one of the group consisting of PEEK resin, PEK resin or PEKK resin; and
glass flake.

2. The compound of claim 1, further comprising glass fiber.

3. The compound of claim 1 having a resin ratio of less than 100%

4. The compound of claim 3, wherein said resin ratio is between 60% and 80%.

5. The compound of claim 2, having a glass flake to glass fiber ratio of 2 to 1.

6. The compound of claim 4, further comprising glass fiber.

7. The compound of claim 6, having a glass flake to glass fiber ratio of 2 to 1.

8. The compound of claim 1, wherein said resin is a combination of high and low viscosity resins.

9. The compound of claim 2, wherein said resin is a combination of high and low viscosity resins.

10. The compound of claim 3, wherein said resin is a combination of high and low viscosity resins.

11. The compound of claim 4, wherein said resin is a combination of high and low viscosity resins.

12. The compound of claim 5, wherein said resin is a combination of high and low viscosity resins.

13. The compound of claim 6, wherein said resin is a combination of high and low viscosity resins.

14. The compound of claim 7, wherein said resin is a combination of high and low viscosity resins.

15. A method of fabricating a reinforced item comprising
providing a compound comprising one of the group consisting of PEEK, PEK or PEKK resin; and glass flake and
extruding said compound by rod or sheet extrusion.

16. A method of fabricating a reinforced item comprising:
providing a compound comprising one of the group consisting of PEEK, PEK or PEKK resin; and glass flake and
molding said compound to form the part.

17. The method of claim 16, wherein said molding is compression molding.
